(19) United States
(12) Patent Application Publication
(10) Pub. No.: US 2015/0081728 A1
(43) Pub. Date: Mar. 19, 2015

(54) AUTOMATIC FORMAT CONVERSION

(71) Applicants: Alon ROSENBERG, Kfar Saba (IL); Assaf STERN, Givat Ada (IL)

(72) Inventors: Alon ROSENBERG, Kfar Saba (IL); Assaf STERN, Givat Ada (IL)

(21) Appl. No.: 14/335,913

(22) Filed: Jul. 20, 2014

Related U.S. Application Data
(60) Provisional application No. 61/894,444, filed on Oct. 23, 2013.
(60) Provisional application No. 61/878,626, filed on Sep. 17, 2013.

(51) Int. Cl. G06F 17/30; G06Q 10/06

(52) U.S. Cl. CPC G06F 17/30011; G06Q 10/0633
USPC 707/756

(57) ABSTRACT

A method of automatically mapping a transaction schema to a supply chain management system, comprising: receiving a XML document schema and type; retrieving a corresponding dictionary comprising unified format keys; parsing the document file; retrieving a XML tag; understanding the tag; and mapping the tag to one of said dictionary's keys.

### CROSS-REFERENCE TO RELATED PATENT APPLICATIONS

This patent application claims priority from and is related to U.S. Provisional Patent Application Ser. No. 61/878,626, filed 17 Sep. 2013, and to U.S. Provisional Patent Application Ser. No. 61/894,444, filed 23 Oct. 2013, these U.S. Provisional Patent Applications incorporated by reference in their entirety herein.

### FIELD OF THE INVENTION

The present invention is in the field of computerized supply chain management systems and pertains more particularly to inputting documents to the system and automatically converting them to an internal format.

### BACKGROUND

Supply chain management is considered nowadays as one of the most prominent subjects in the Information Technology (IT) domain and is characterized by the fastest growth rate in the Enterprise IT domain and with many technological developments.

A supply chain management system is a software platform for electronic connectivity between businesses (B2B). The platform enables the creation of a cooperative electronic commerce community for clients, suppliers and business partners, for performing all the supply-chain related activities automatically and electronically.

### BRIEF DESCRIPTION OF THE DRAWINGS

For better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is a schematic functional representation of a supply chain management system;

FIG. 2 is a schematic functional representation of the interface layer ;

FIG. 3 is a schematic functional representation of the services layer;

FIG. 4 is schematic representation of the functional modules invoked by the process manager and their inter-relations;

FIG. 5 is a schematic representation of the automatic mapping service connectivity;

FIG. 6 is a flowchart showing the main steps of automatically mapping new document schemas according to embodiments of the present invention;

FIG. 7 is a flowchart showing the various steps taken by the mapping process for understanding a tag name;

FIG. 8 shows schematically the elements participating in the automatic mapping process and the way they relate to each other;

FIG. 9 shows an exemplary weighted graph of similar words and phrases; and

FIG. 10 is a schematic representation of the conversion process carried out by the conversion module.

### DETAILED DESCRIPTION OF PREFERRED EMBODIMENTS

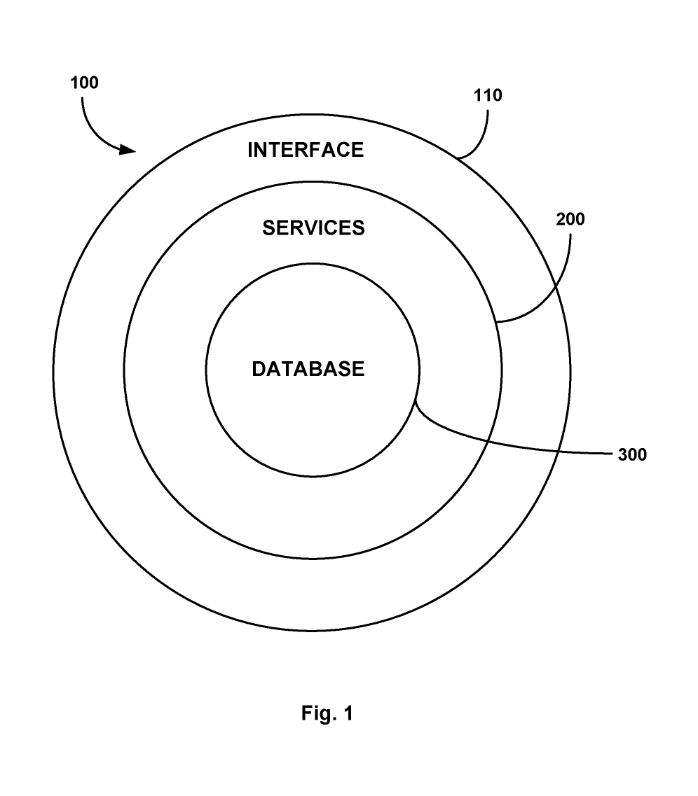

FIG. 1 is a schematic functional representation of a supply chain management system 100. The system 100 is transaction-motivated, where a transaction may be any business related document (e.g. purchase order, invoice, etc.) provided to the system by one of its users (e.g. client) and intended for another system user (e.g. supplier).

The system 100 comprises three main functional layers which interact with each other to provide the required capabilities: interface layer 110, services layer 200 and database 300.

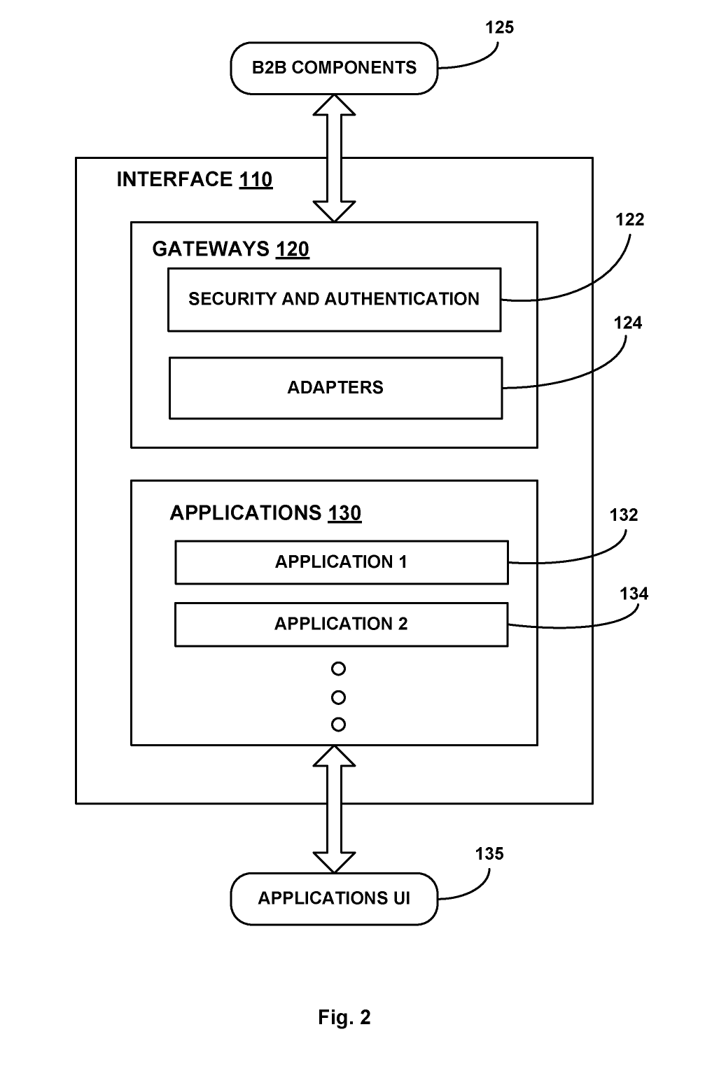

FIG. 2 is a schematic functional representation of the interface layer 110, which connects the system 100 with its users for inputting messages and transactions into the system and receiving messages and transactions from the system. Several modes of communication may be supported. For example, the system may communicate directly with B2B components 125 comprising, for example, modules of the user's ERP system. Transactions received from B2B components may be directed by the system to various gateways 120, such as, for example, RosettaNet, CXML and EDI, for security and authentication checks 122 and for conversion of the transaction in the B2B component format into a common system data format (e.g. XML) by a suitable adapter 124.

An additional or alternative mode of communication between the system and the users may be provided, namely direct interaction mode, where the user is provided with user interfaces (UI) 135 to various applications 130, enabling her to enter transaction data into the system and receive data from the system. The applications may be provided as web services or as client applications communicating with a server application. The applications may allow operations such as, for example, database searches, reports creation, transactions creation (e.g. create an invoice from an order), etc.

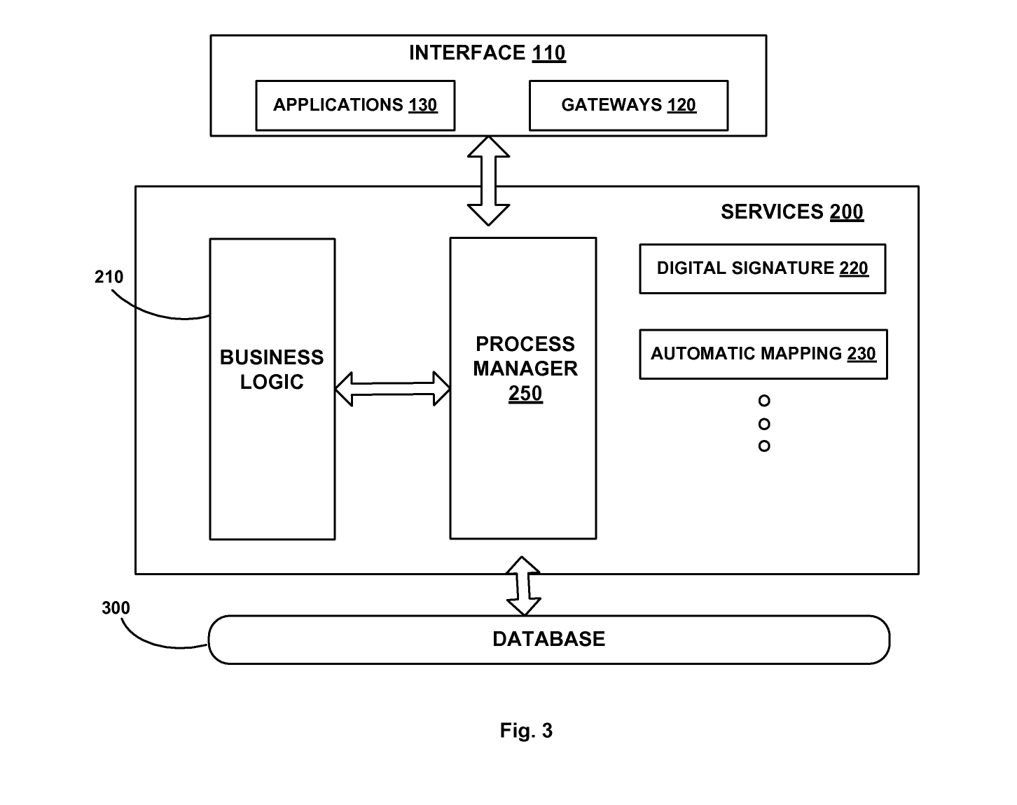

FIG. 3 is a schematic functional representation of the services layer 200, which mediates between the interface layer 110 and the database 300 to enable the various system operations. At the core of service layer 200 are the process manager 250 and the business logic module 210.

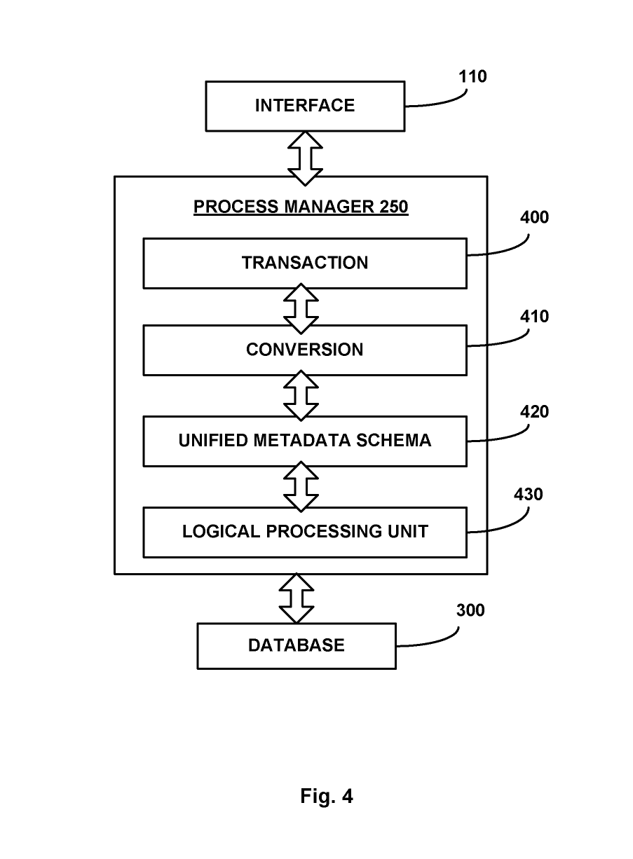

Process manager 250 is in charge of receiving B2B transactions and messages from the gateways 120 and managing the business process by invoking the appropriate services 200 in the right order, as will be explained in detail in conjunction with FIG. 4.

Business logic module 210 separates business logic from other system modules. It receives requests from the applications 130 and handles them according to request type. For example, business logic module 210 may create a transaction such as a new invoice as a result of user activity in an application and pass it on to the process manager 250 for further handling. In another example, the business logic module 210 may receive a request for a report via an application, e.g. “show all the open orders of a user”, which it may handle internally in compliance with a predefined set of permissions, etc.

Database 300 stores transactions and messages. Transactions may be stored in any suitable format for further processing such as XML or a proprietary format. Database 300 may additionally store transaction (e.g. invoices) images in a format such as PDF.

FIG. 4 is schematic representation of the functional modules invoked by the process manager 250 and their inter-relations. Transaction module 400 receives a transaction from the interface layer 110, saves it in the database and transfers it to the conversion module 410 for conversion from e.g. native XML to a proprietary internal format (UMS 420). The conversion process includes translation of the data structure and contents, completing missing data or correcting data according to pre-stored business logic data (e.g. in the order line the Total Line Quantity may be missing and the conversion process can calculate this information and derive it from the Quantity and Unit Price fields) and storing in database 300. The processed transaction is passed on to the logical processing unit (LPU) which identifies the relevant business event, e.g. new order, invoice status or warehouse receipt, etc., the transaction source and destination and its place in the business process as defined for the sender and receiver in the business logic module 210.

The LPU may put a transaction on hold, e.g. in wait for additional event, or initiate a process in response, e.g. sending a received purchase order to the supplier. The initiated process gets the transaction from the database 300 and transfers it to the interface layer 110 for delivery to its destination in the appropriate format.

According to embodiments of the invention, the Unified Metadata Schema (UMS) comprises a plurality of dictionaries, each pertinent to a different type of business object (transaction document), e.g. invoice, purchase order, etc. The dictionary holds a unique key for each field in the source and target schemas of the document.

Whenever a new user registers to the system or an existing user wishes to introduce a new document format to the system, the new document(s) schema(s) have to be mapped into the appropriate UMS dictionary.

According to embodiments of the invention, an automatic mapping process 230 (FIG. 3) automatically maps between a schema of business object and the UMS dictionary. Mapping includes understanding the data structures and sequences in complex structures and mapping the tags.

The desired result of automatic mapping is to minimize the manual work of mapping new partners or maintaining changes in configuration by suggesting the correct map or completely configure the mapping process on approved mapping.

The general assumption is that any data structure would be describable by XML scheme. Therefore, in order to understand the meaning of any data element, we have to understand the meaning of the tag text as well as its context. For example, tag name ‘FirstName’ would be a first name of a person, but if the this tag appears under ‘Buyer’ then the meaning would be the buyer's first name, etc.

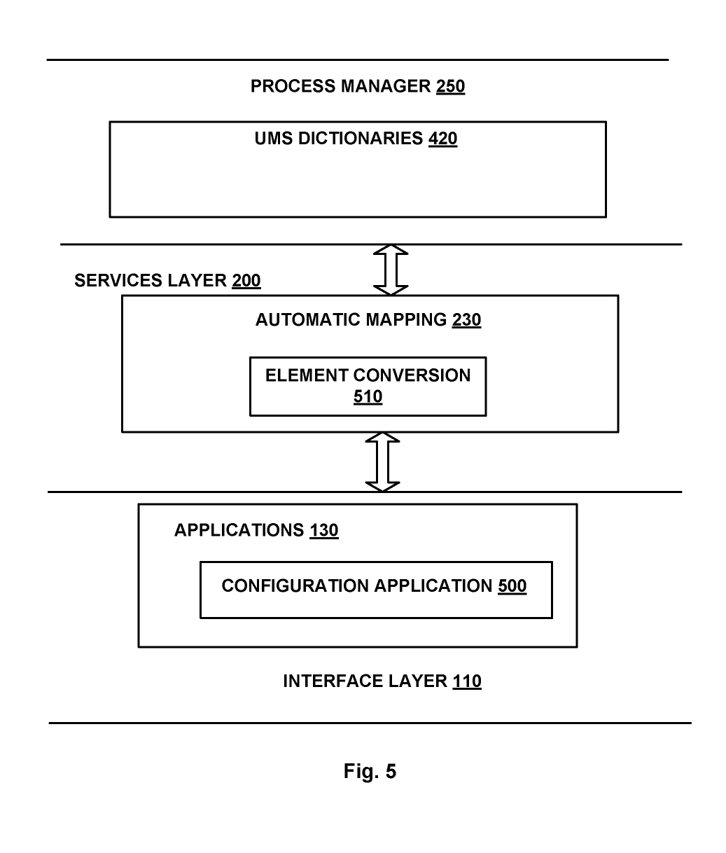

FIG. 5 is a schematic representation of the automatic mapping service 230 connectivity according to embodiments of the present invention. Automatic mapping service 230 is connected with the interface layer 110, for receiving XML documents from the configuration application 500 and with the database 300 for storing mapped new schemas and updating UMS dictionaries. Automatic mapping service 230 includes an element conversion module 510, as will be explained in detail below.

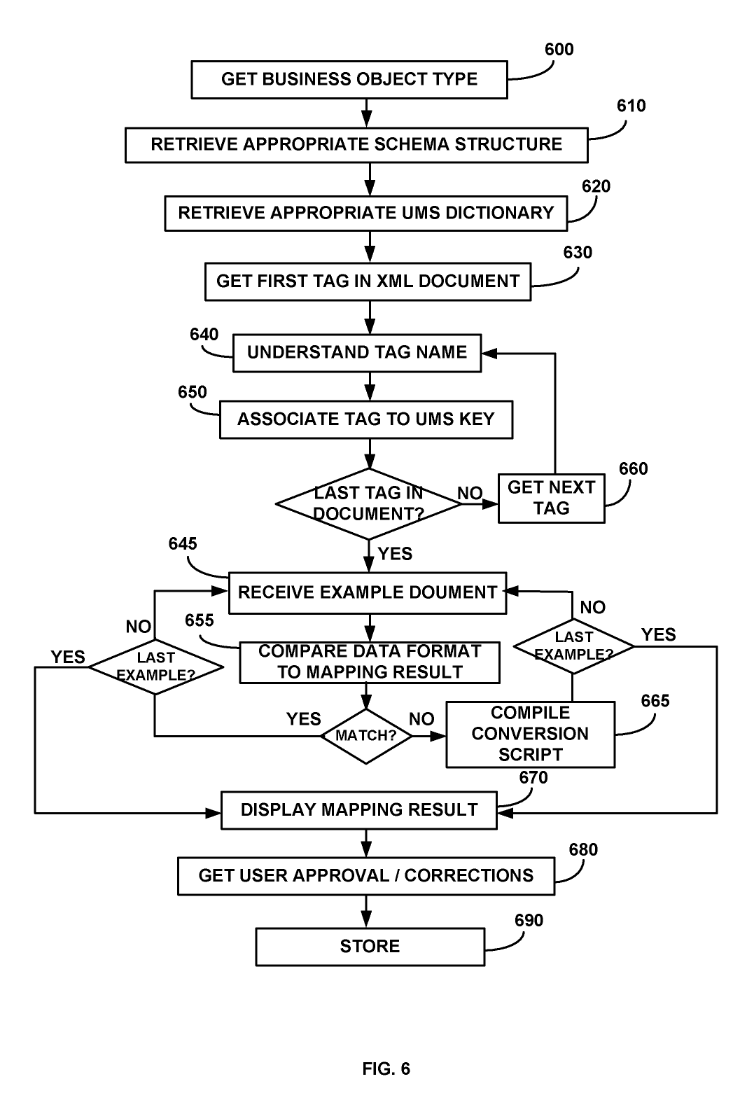

FIG. 6 is a flowchart showing the main steps of automatically mapping new document schemas according to embodiments of the present invention.

In step 600 the process receives the business object's type, which may be any business object such as a purchase order, an invoice, a payment notification, etc. and retrieves (610) the appropriate schema type and (620) UMS dictionary. The schema includes the expected set of structures and the UMS dictionary includes all UMS keys that should be mapped to data elements in the document.

In step 630 the process starts parsing the document XML file and retrieves the first XML tag.

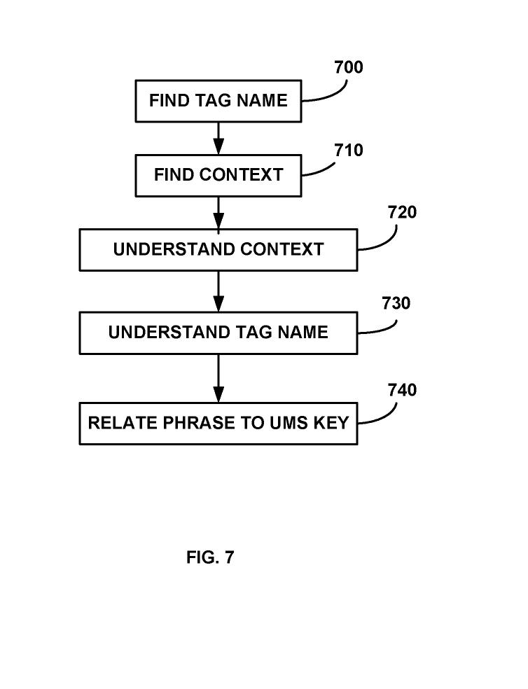

In step 640 the process attempts to “understand” the tag, as detailed in FIG. 7.

If more tags exist in the XML document, the process proceeds (660) to “understand” the next tag. Otherwise (645) the process prompts the user to upload an exemplary document in order to test the automatically created mapping between the various data fields and the UMS keys.

In step 655 the process scans the uploaded document, retrieves the mapped key for each data field and compares the actual data format to the mapped key and checks whether any required key is missing. When deemed necessary, the process invokes an application generator that presents the user with a friendly UI to define required transformations, obtaining missing data, etc. The application generator generates a script based on the user's inputs.

For example:

1. An invoice document contains quantity and unit price per row, but the value of total price per row, required by the unified invoice format is missing—A script for creating a derived data element by multiplying unit price and quantity for each row is built by the process and added to the conversion module 410.

2. A transaction document defines a recipient's first name and last name in two separate fields, but the unified name format for this transaction type requires a single name field—A script for creating a derived data element by combining the two name fields into one field is built by the process and added to the conversion module 410.

3. A transaction document defines a recipient's full address in one field, but the unified address format for this transaction type requires separate fields for the city and country—A script for creating a derived data element by separating the address field into a number of fields is built by the process and added to the conversion module 410.

4. A transaction document defines prices in a format different than the price format required by the unified format for this transaction type—A script for transforming the price number into the required format (e.g. 2 decimal digits) is built by the process and added to the conversion module 410.

5. A transaction document requires a “cost of shipment” field which may be added to the customer's invoice or may alternatively be borne by the supplier. A script for determining whether to add shipment cost to an invoice, derived from the business logic 250 defined for the specific transaction type, is built by the process and added to the conversion module 410.

6. A transaction may lack data required by the other side, e.g. an invoice sent to a specific customer may require data from the original order or from the shipping bill—A script for retrieving the required data from the system's database is built by the process and added to the conversion module 410.

7. A transaction may require ad hoc data (e.g. exchange rate)—A script for retrieving the required data from outside sources (e.g. the federal bank website) is built by the process and added to the conversion module 410.

The built scripts are invoked by the conversion module 410 whenever a transaction of the same type originating from the same source is received by the system, or whenever a transaction of the same type addressed to the same recipient is sent by the system.

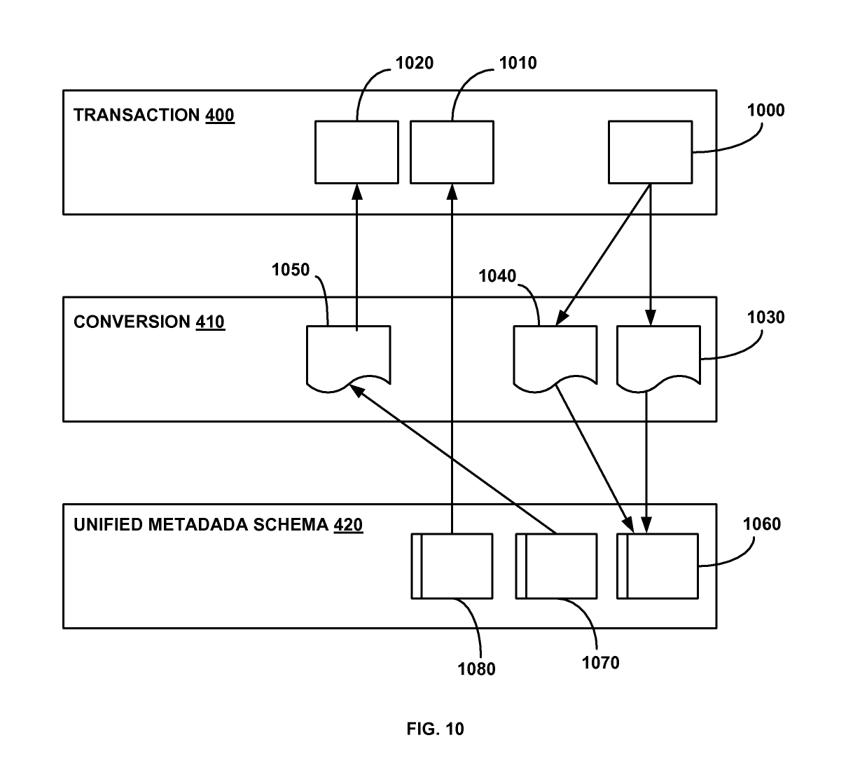

FIG. 10 is a schematic representation of this conversion process showing 3 exemplary transactions 1000, 1010 and 1020.

Transaction 1000 is a transaction received by the system, in which two data fields require to be converted using system created scripts 1030 and 1040 before being mapped to a UMS key in UMS dictionary 1060 and stored in the system database.

Transaction 1010 is a transaction sent by the system, which require no special conversion from the transaction mapped in UMS dictionary 1070 and stored in the system database.

Transaction 1020 is a transaction sent by the system, in which one data field requires to be converted using system created script 1050 before being mapped to a UMS key in UMS dictionary 1080 and stored in the system database.

Returning to FIG. 6, the process continues to prompt the user to upload test documents of the same type and test them using the derived mapping newly created scripts, until the process determines that the mapping is completed or the process is stopped by the user.

In step 670 the mapping is displayed, preferably as an overlay over the displayed document in the configuration application 500.

In step 680 an interactive session takes place in which the user is prompted to point out missing structures, e.g. structures not identified by the process and/or correct faulty “understandings” by the process.

Although we provide several different algorithms to associate the XML tag to UMS key, it is just a supporting system for the user's decision. Based on user activity (e.g. in step 680) the system can improve the algorithms for automatic mapping.

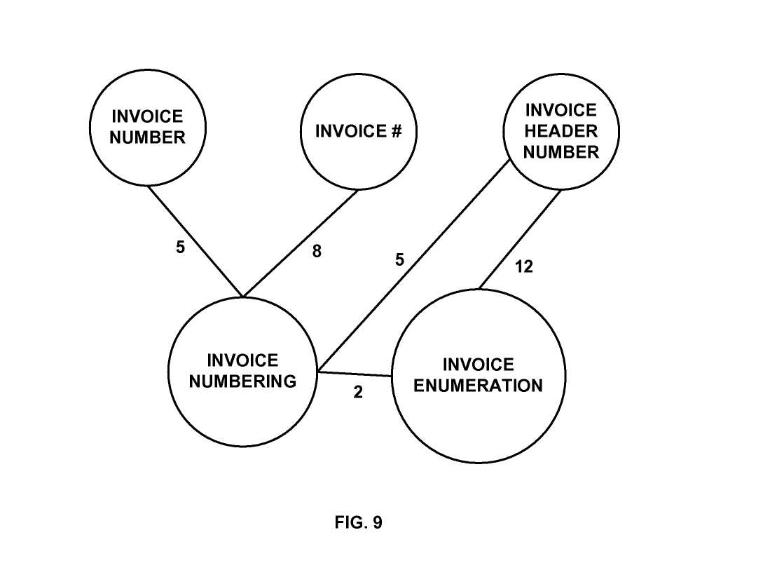

The system may maintain a weighted graph of words and phrases, based on user input, which will be used for future automatic mapping. An exemplary graph is depicted in FIG. 9. Every vertex in the graph may hold a single English phrase. The weights of the edges represent the relation between two vertices or phrases. The larger the number the closer the relationship. Zero means no relation and therefore the edges are removed. When user approves a suggestion the process increments the weight of the appropriate edge by one point; otherwise the process decreases the weight by five pints. A maximum weight may be set, which implies that the two phrases are an exact match, namely synonyms.

This mechanism can even be used to find relations between two phrases that have no common edge. In this case the relationship would be determined by adding the sum of all weighted edges, then dividing by the number of connecting edges and dividing again by a factor. The maximum number of edges and the factor should be configured using real data.

FIG. 7 is a flowchart showing the various steps taken by module 640 (FIG. 6) of the automatic mapping process.

For every element in source XML do the following:

{
Find tag name (step 700) - The tag name is the last element in an XML
phrase. For example:
3A4_PurchaseOrderConfirmation_MSV020_01\ServiceHeader\
KnownInitiatingPartner\PartnerIdentification\Domain\
GlobalBusinessIdentifier = VenbdorIdentification
Find context (step 710) - The context consists of the XML up to the
tag name.
For example:
3A4_PurchaseOrderConfirmation_MSV020_01\0ServiceHeader\
KnownInitiatingPartner\PartnerIdentification\Domain\
GlobalBusinessIdentifier = VenbdorIdentification
//now we are trying to understand the context (step 720)
Break context to elements
For example:
3A4_PurchaseOrderConfirmation_MSV020_01
ServiceHeader
KnownInitiatingPartner
PartnerIdentification
Domain
For every element:
{
Break element into atomic words
For example:
3A4
Purchase
Order
Confirmation
MSV020
01
Service
Header
Known
Initiating
Partner
Partner
Identification
Domain
Using element words relate to a known group
}
//now we are trying to understand the tag name (step 730)
Break tag name into words
For example:
Global
Business
Identifier

Using tag name words relate tag to known group.

Relating words to groups consists of finding the best matched group for the word, where the groups are continuously updated with new related words.

//combining together we are relating the whole phrase (context & tag name)
to a known UMS key (step 740)
Using context group relation and path order + tag name group, relate the
given tag to a UMS Key.
}

A number of methods may be used for the task of “understanding” a tag name or context, including but not limited to:

### Verbal Comprehension

The very basic feature is to associate basic words to a business meaning. The system may hold a list of words and phrases that are associated with UMS keys and context groups. For example, ‘Delivery Date’, ‘Requested Date’ and ‘Line Date’ may be different phrases for a single UMS key named ‘DeliveryDate’ representing the requested delivery date of a single item in the order by the customer.

### Dictionary, Synonym and Antonym

If an exact match for a word is not found in a list, the process may access online dictionaries, search for the word, and try to find phrases we understand there. Alternatively, we can search synonyms for the given word.

### Conventions

Usually XML tags are not in standard English format, namely there are no spaces between words, and in many cases there is use of abbreviation or industry unique meaning.

The process attempts to extract English words or abbreviations out of the tag name. In many cases, the common practice is to capitalize the first letter in a word or separate words by underscore ‘ ’. Once we separated the words, we need to try to associate them with our known list of words and phrases. In many cases, the words would not be in Standard English then we will try to use industry conventions, e.g. ‘PONum’ would be Purchase Order Number.

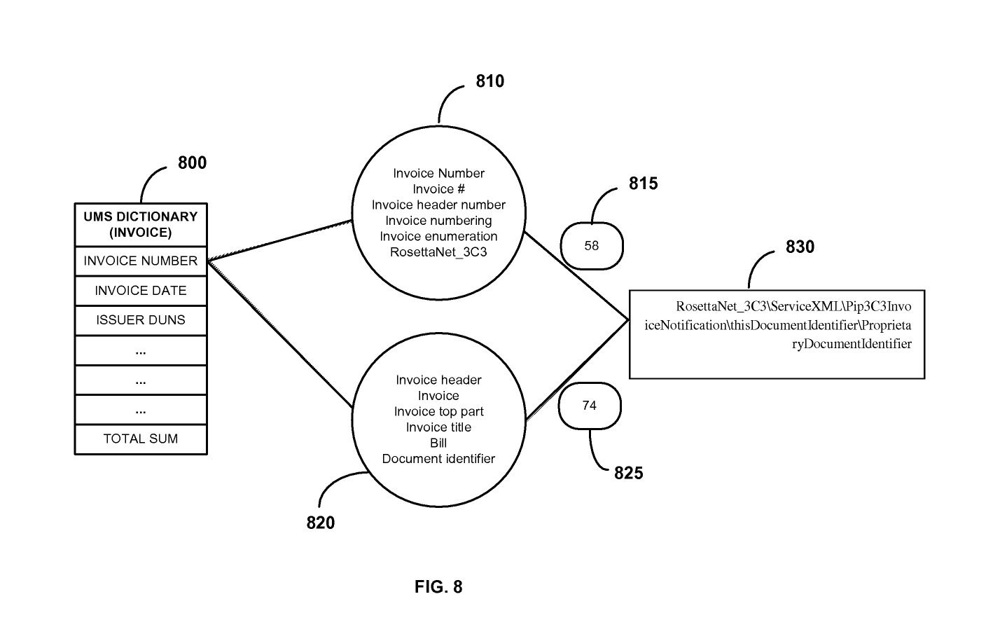

FIG. 8 shows schematically the elements participating in the automatic mapping process and the way they relate to each other, comprising:

A UMS dictionary for invoices 700.

Phrase groups 710 and 720 pre-associated with the matching UMS keys.

An exemplary XML tag 730 matched by the algorithm with the two phrases groups with respective scorings 715 and 725.

1. A supply chain management system comprising:
a system server comprising a central processor and a database;
a plurality of user computers communicating with the system server over a network;
said system server running a software process defining:
an interface layer configured to communicate messages and business transactions bi-directionally between said user computers and said system server; and
a services layer configured to apply business logic to said messages and business transaction and process them according to a predefined workflow of said supply chain management system, said service layer comprising dictionaries storing a unique internal format representation for each transaction field;
said plurality of user computers running client applications configured to communicate with said interface layer, said client applications comprising a configuration application configured to introduce new document schemas to the system;
said service layer comprising an automatic mapping service configured to communicate bi-directionally with said configuration application and with said dictionaries.

2. The system of claim 1, wherein said automatic mapping service is configured to receive a XML transaction schema, identify tags in the XML schema, understand the identified tags and relate them to appropriate dictionary entries.

3. The system of claim 1, wherein said automatic mapping service is configured to create conversion scripts for converting transaction data fields to the appropriate internal format representation.

4. A method of automatically mapping a transaction schema to a supply chain management system, comprising:
receiving a XML document schema and type;
retrieving a corresponding dictionary comprising unified format keys;
parsing the document schema;
retrieving a XML tag;
understanding the tag; and
mapping the tag to one of said dictionary's keys.

5. The method of claim 4, further comprising displaying said mapped tag and said dictionary key to a user.

6. The method of claim 4, wherein said understanding the tag comprises:
finding the tag name;
finding the tag context;
understanding the tag context; and
understanding the tag name.

7. The method of claim 6, wherein said understanding the tag name comprises matching said tag name to weighted tree entries comprising similar words or phrase.

8. The method of claim 6, further comprising adding said tag name to a weighted tree's entries comprising similar words or phrase.

9. The method of claim 5, further comprising creating conversion scripts for converting transaction data fields to the appropriate internal format representation.
